(19) United States
(12) Patent Application Publication
(10) Pub. No.: US 2006/0232906 A1
(43) Pub. Date: Oct. 19, 2006

(54) Surge detector/counter

(76) Inventor: Yoshiharu Sueoka, Gardena, CA (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/367,651

(22) Filed: Mar. 3, 2006

Related U.S. Application Data
(60) Provisional application No. 60/658,262, filed on Mar. 3, 2005.

(51) Int. Cl. H02H 9/06

(52) U.S. Cl. 361/118

(57) ABSTRACT

A combination surge detector/counter device that detects and counts various surge conditions that occur during a specified time interval. The device includes a surge detector circuit which generates a surge voltage signal in response to the occurrence of a surge condition at an input AC power source. The surge detector includes a surge suppressor, such as a metal oxide varistor (MOV), coupled in series with a current sensor such as a toroid transformer. In response to a surge condition, the surge suppressor generates a surge current signal which is converted into a surge voltage signal by the current sensor. To improve the sensitivity of the detector, a portion of a lead of the surge suppressor may be arranged to extend through a central opening of the current sensor. The surge voltage signal is processed by a surge sensitivity selector which provides a plurality of user selectable voltage sensitivity levels. A surge sensitivity circuit further processes the surge voltage signal from the sensitivity circuit to determine a count of the number of occurrences of surges or surge conditions at the input of the detector. A storage means such as a capacitor can be used to store the count-value even after the device is disconnected from the AC power source. A display means can be coupled to the output of the device to display the number of occurrences of surge conditions.

This application claims the benefit of the filing date of a provisional application having Ser. No. 60/658,262 which was filed on Mar. 3, 2005.

### BACKGROUND OF THE INVENTION

1. Field of the Invention

The present invention relates to surge devices. More specifically, this invention relates to a surge detector/counter.

2. Description of the Related Art

Surge arresters are used to prevent the insulation breakdown of a conductor. For example, an overhead transmission tower supports cables having electrical conductors for carrying high voltage electrical power from a generating plant to a substation, and then, at lower voltages, to end users, such as residential, commercial and industrial users. The insulation between conductors on the overhead transmission lines is provided by the air space between the conductors. A surge arrester can prevent arcing between the power lines by diverting voltage caused by a transient overvoltage condition to a ground return path. The overvoltage condition may be attributed, for example, to lightning or capacitor bank switching. In an underground electrical system, where plastic or rubber insulation is employed, a surge arrester can prevent damage to the insulation around the various conductors.

Surge suppressors, like surge arresters, are voltage clamping devices, which are employed to protect a load, such as, for example, appliances, computers and other electrical equipment, from surges. Surge suppressors can clamp the load voltage at a suitable voltage level, which is less than the clamping voltage of the surge arrester. At the same time, surge suppressors can protect such electrical equipment from internal surge sources, which result from the operation of electrical equipment such when a motor switches, a switch disconnects a load or other conditions. Surge suppressors, thus, can protect a load from both external sources such as lightning voltage remnants and internal disturbances such as caused by other equipment. Surge suppressors typically include one or more capacitors to filter high frequency noise.

There are various types of surges or surge conditions. For example, as defined by Institute of Electrical and Electronics Engineers (IEEE) C62.41, there are three types of surges: (1) oscillatory surges or “ring waves” (e.g., a surge delivered to an electrical system excites natural resonant frequencies and, as result, has an oscillatory waveform less than about 1 kHz to 500 kHz, and may have different amplitudes); (2) high energy surges resulting from, for example, lightning, opening of a fuse, or power factor capacitor switching; and (3) a burst of very fast surges resulting from opening of air-gap switches or relays, which are typically represented by a 5 ns rise time and a 50 ns duration with various amplitudes. IEEE C62.41 also defines location categories with representative waveforms such as, for example: (1) Category A: outlets and branch circuits; (2) Category B: feeders, short branch circuits and distribution panels; and (3) Category C: outside and service entrance, such as the run between a meter and a panel.

There is a need for a device that can handle various types of surges or surge conditions.

### SUMMARY OF THE INVENTION

The present invention provides a combination surge detector/counter device that detects and counts various types of surges or surge conditions that occur during a specified time interval. The device includes a surge detector circuit which generates a surge voltage signal in response to the occurrence of a surge condition at an input AC power source. The surge detector includes a surge suppressor, such as a metal oxide varistor (MOV), coupled in series with a current sensor such as a toroid transformer with a magnetic core. In response to a surge condition, the surge suppressor generates a surge current signal which is converted into a surge voltage signal by the current sensor. To improve the sensitivity of the detector, a portion of a lead of the surge suppressor may be arranged to extend through a central opening of the magnetic core of the toroid. The surge voltage signal is processed by a surge sensitivity selector circuit which includes a switch that provides a range of user selectable voltage sensitivity levels to process a range of applications. The selector switch is configured to have a positive reset between each setting thus automatically resetting when a new sensitivity is selected. A surge voltage processing circuit further processes the surge voltage signal to determine a count of the number of occurrences of surges or surge conditions at the input of the detector. A storage means such as a capacitor can be used to store the count value even after the device is disconnected from the AC power source. A display means can be coupled to the output of the device to display the count representing the number of occurrences of surge conditions.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for the designing or modifying other structures for carrying out the same purposes of the present invention and that such other structures do not depart form the spirit and scope of the invention in its broadest form.

### BRIEF DESCRIPTION OF THE DRAWINGS

Other aspects, features and advantages of the present invention will become more fully apparent from the following detailed description, the appended claim, and the accompanying drawings in which similar elements are given similar reference numerals:

FIG. 1 is a block diagram of a surge detector/counter device according to an embodiment of the present invention;

FIG. 2 is a schematic diagram of the surge detector circuit of FIG. 1;

FIG. 3 is a schematic diagram of the selector circuit of FIG. 1;

FIG. 4 is a schematic diagram of the surge processing circuit of FIG. 1;

FIG. 5 is a schematic diagram of the power supply circuit of FIG. 1; and

FIG. 6 is a diagram of the surge detector circuit of FIG. 1.

### DETAILED DESCRIPTION OF THE INVENTION

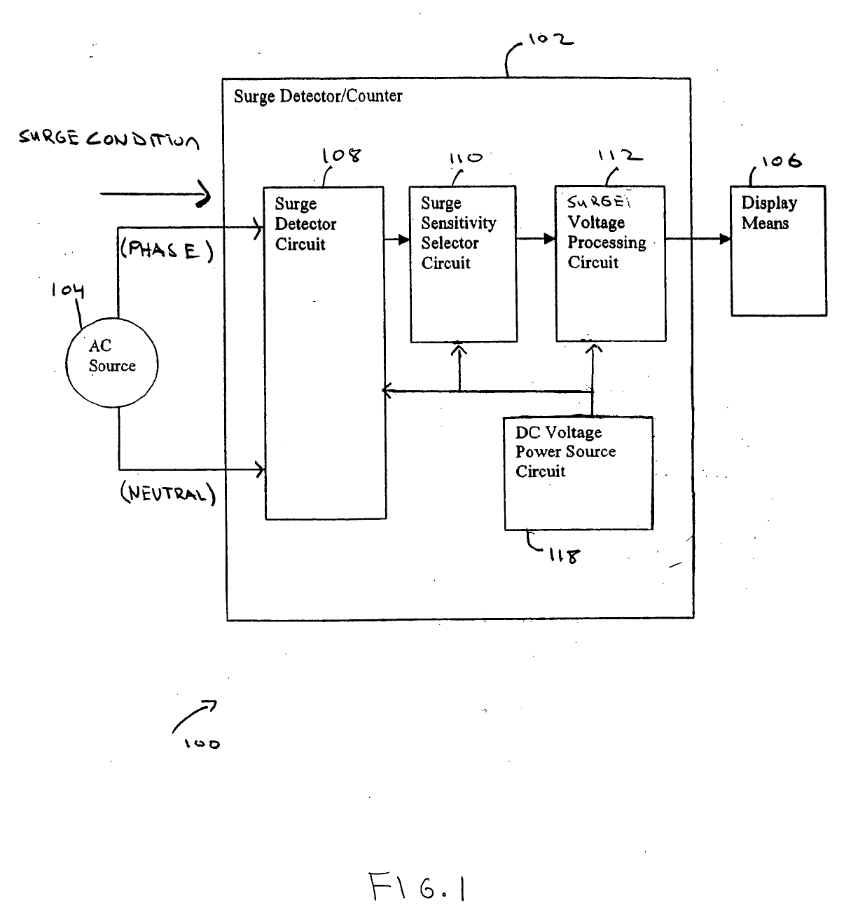

Referring to FIG. 1, there is illustrated a block diagram of an electrical measurement system 100 having a surge detector/counter device 102 for detecting and counting surge conditions present at an AC power source 104 and displaying the number of surge conditions on a display means 106. A surge condition can be defined as an increase in the peak voltage waveform, at the same nominal frequency, lasting longer than one-half of a cycle. For a 60 Hz system the duration is longer than 8.33 milliseconds. The surge detector/counter device 102 is electrically coupled across power conductors (e.g., Phase and Neutral conductors) of the AC power source 104 which can be a typical 120V, 60 Hz power source found in a residential setting such as a home. The surge detector/counter device 102 includes a surge detector circuit 108 for detecting surge conditions across the AC power source 104 and a surge sensitivity selector circuit 110 for providing a means of selecting a sensitivity level for processing the surge conditions. The output of the surge sensitivity circuit 110 is coupled to a surge voltage processing circuit 112 which has a storage means for storing the surge voltage and a processing means to determine a count value representing the total number of surge conditions that have occurred over a time period. The output of the surge voltage processing circuit 112 is coupled to display means 106 for displaying the number of surge conditions. A direct current (DC) voltage power source circuit 118 is coupled to the AC power source 104 to provide DC power to the components of the device 102. Although the surge detector/counter circuit 102 is described in the context of an AC power source found in residential setting such as a home, it should be understood that the principles of the present invention are equally applicable to other settings such as commercial and industrial settings that are subject to surge conditions.

In operation, the surge detector circuit 108 generates a surge voltage signal in response to a surge condition at the AC power source. The surge sensitivity selector circuit 110 processes the surge voltage signal based on the selected sensitivity level. The surge voltage processing circuit 112 stores the surge voltage and processes the voltage signal to determine a count value representing the total number of surge conditions that have occurred over a time period. The count can be displayed by display means 106 and/or further processed by another external device. If the device is disconnected from the power source, the storage means of the processing circuit 112 stores the count for a time period such as, for example, 5 days.

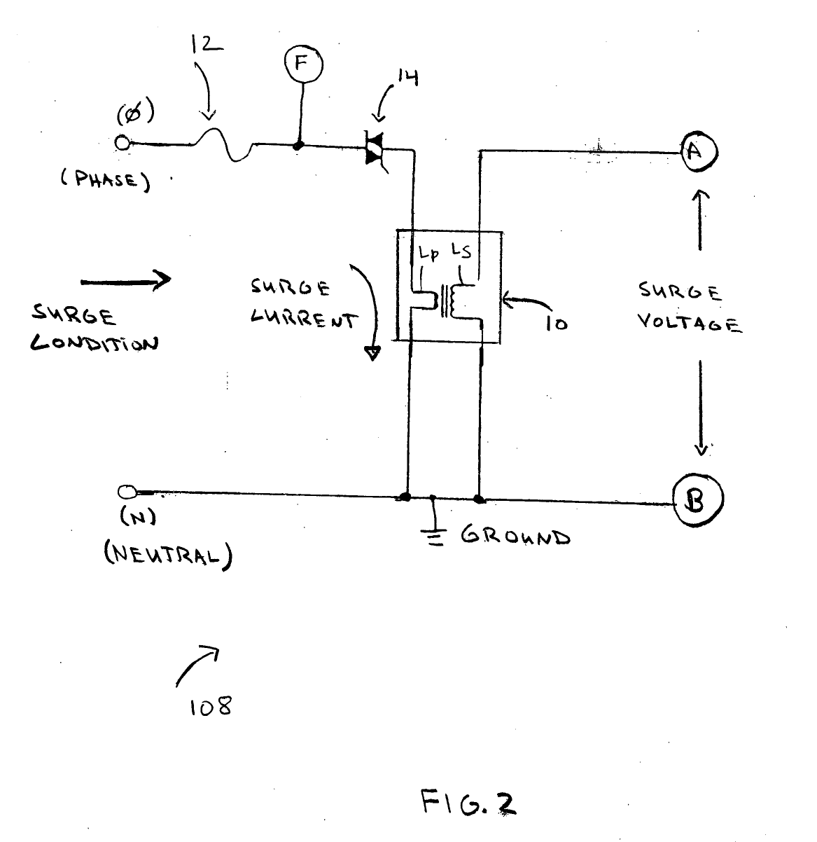

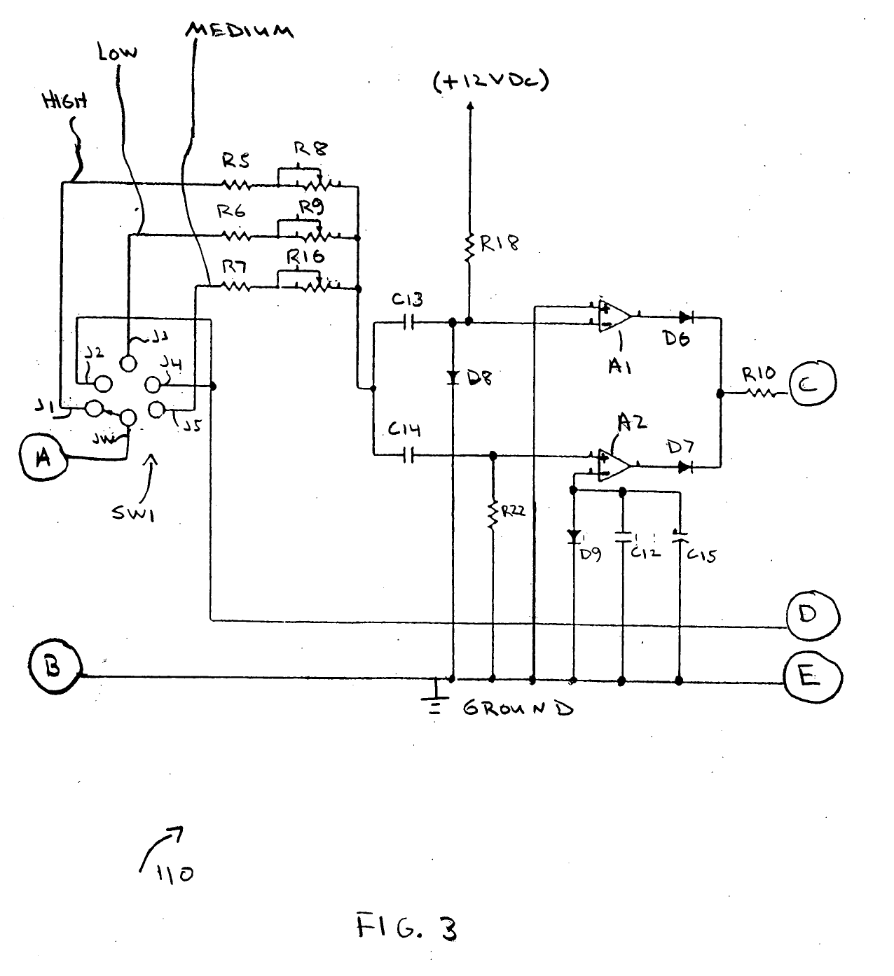

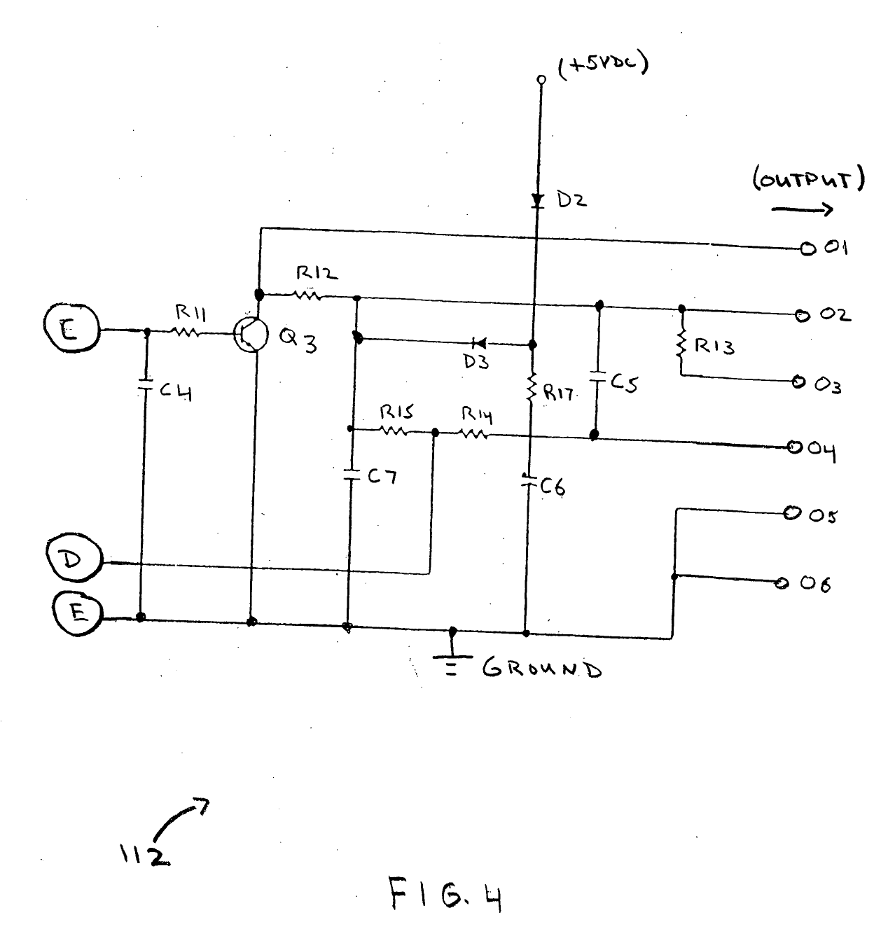

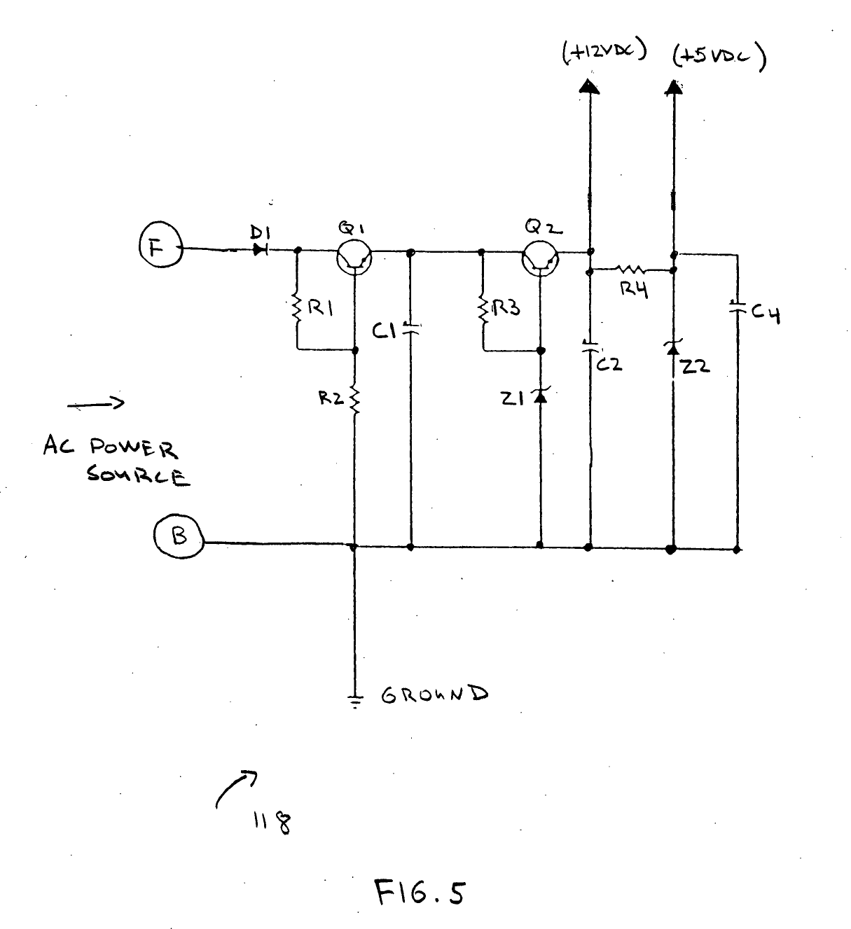

A schematic diagram of the surge detector/counter circuit 102 of FIG. 1 is shown in the following schematic diagrams: FIG. 2 shows the surge detector circuit 108; FIG. 3 shows the surge sensitivity selector circuit 110; FIG. 4 shows the surge voltage processing circuit 112; and FIG. 5 shows the DC power supply circuit 118.

Referring to FIG. 2, the surge detector circuit 108 includes an input Phase terminal for connection to the Phase conductor of an AC power source (not shown) and a Neutral terminal for connection to the Neutral conductor of the AC power source. Although not shown, a ground terminal of the AC power source can be connected to the Ground terminal of the circuit 108. The surge detector 108 includes a current sensor 10 with one terminal coupled to the Phase terminal and a second terminal coupled to the Neutral terminal and the Ground terminal. The current sensor 10 is shown as a toroid transformer having a magnetic core with a primary section LP and a secondary section LS wound with wire. A fuse 12 and a surge suppressor 14 are coupled in series with the Phase terminal and the top end of the current sensor 10. The surge suppressor 14 is shown as a metal oxide varistor (MOV) to allow a surge current to flow as long as the voltage from a surge condition does not exceed the voltage rating of the MOV. The fuse 12 disconnects the AC power source from the circuit when the magnitude of the input current from the AC power source is above a certain level such as the fuse rating of the fuse. The secondary section LS of the current sensor 10 provides an output surge voltage based on a surge current at the primary section LP which is present when a surge condition occurs.

Referring to FIG. 3, the surge sensitivity selector circuit 110 provides a means of selecting a sensitivity level for processing the surge voltage produced at the secondary section LS of the current sensor 10 (FIG. 2). In one embodiment, a five position rotary switch SW1 provides three selectable sensitivity levels: High, Medium and Low.

The High level setting is provided by a first series resistor combination of resistor R5 and potentiometer R8 where one end of the combination is connected to terminal J1 of the switch SW1. The High level setting can be used in applications involving light equipment such as a portable paper shredder or a heat gun. The Low level setting is provided by a second series resistor combination of resistor R6 and potentiometer R9 where one end of the combination is connected to terminal J3 of the switch SW1. The Low level setting can be used in applications involving heavy equipment or large inductive loads. The Medium level setting is provided by a third series resistor combination of resistor R7 and potentiometer R16 where one end of the combination is connected to terminal J5 of the switch SW1. The other end of the first, second and third series resistor combinations is connected to one end of capacitors C13 and C14. The terminal Jw is connected to an output winding of the secondary section LS of the current sensor 10. Terminals J2 and J4 are connected together and provide an automatic means for resetting a voltage across capacitor C7 (FIG. 4) which represents the input surge condition. For example, changing the setting from the High level (terminal J1) to the Low level (terminal J3) causes the switch SW1 to traverse across terminal J2 which provides a path for capacitor C7 to discharge through the Ground terminal. Thus, this technique provides a positive reset between each setting thus automatically resetting when a new sensitivity is selected.

Amplifiers A1 and A2 process the surge voltage from one of the first, second or third resistor combinations based on the selected sensitivity level of the switch SW1. The amplifier A1 is configured as an open ended comparator that receives the surge voltage through the other end of the capacitor C13 and generates an output voltage when a negative portion of the surge voltage signal is of a sufficient magnitude at the inverting input (minus) compared to the reference point at the non-inverting input (plus). The non-inverting input (plus) of amplifier A1 is connected directly to the Ground terminal. A first DC voltage (12 VDC) is connected to the inverting input (minus) of the amplifier A1 through resistor R18. The first DC voltage is provided by the DC power supply circuit 118 of FIG. 5. A diode D8 is coupled across the inverting input of amplifier A1 and the Ground terminal. The output of amplifier A1 is connected to one end of resistor R10 through diode D6.

Likewise, the amplifier A2 is configured as an open ended comparator that receives the input surge voltage signal through the other end of the capacitor C14 and generates an output voltage when a positive portion of the surge voltage signal is of a sufficient magnitude at the non-inverting input (plus) compared to the reference point at the inverting input (minus). The non-inverting input (plus) of the amplifier A2 is connected to the Ground terminal through resistor R22. The inverting input (minus) is connected to the Ground terminal through the parallel combination of diode D9 and capacitors C12 and C15. The output of amplifier A2 is connected to one end of the resistor R10 through diode D7.

Referring to FIG. 4, the surge voltage processing circuit 112 processes the output voltages from the amplifiers A1 and A2 of the selector circuit 110 (FIG. 3) and provides a count representing the number of surge conditions detected by the surge detector. The base terminal of transistor Q3 is connected to the output of amplifiers A1 and A2 through resistor R11. A capacitor C4 has one end coupled to the base terminal of transistor Q3 through resistor R11 and the other end of the capacitor C4 is directly coupled to the Ground terminal. The emitter of transistor Q3 is directly coupled to the Ground terminal.

Output terminals O1-O6 can be used to connect an external display means, such as a liquid crystal display (LCD) or other display means to further display or process the output voltage representing a surge condition. The output terminal O1 is directly coupled to the collector terminal of transistor Q3. The output terminal O2 is connected to the collector terminal of transistor Q3 through resistor R12. The output terminal O3 is connected to the output terminal O2 through resistor R13. The output terminal O4 is coupled to the collector terminal of transistor Q3 through series combination of resistors R14, R15 and R12. The output terminals O5 and O6 are directly coupled to the Ground terminal.

A second DC voltage (5 VDC) is connected to the collector terminal of transistor Q3 through series diodes D2, D3 and resistor R12. A filter capacitor C8 has one end connected to the Ground terminal and the other end connected to the second DC voltage (5 VDC) through resistor R17 and diode D3. The second DC voltage (5 VDC) is provided by the DC power supply circuit 118 of FIG. 5. The charging capacitor C7 has one end coupled to the collector terminal of transistor Q3 through resistor R12 and the other end of the capacitor C7 is directly connected to the Ground terminal. As described above, the switch SW1 of the surge sensitivity circuit (FIG. 3) provides a reset means to discharge the surge voltage developed across charging capacitor C7.

Referring to FIG. 5, the DC voltage power source circuit 118 produces the first DC voltage (12 VDC) and the second DC voltage (5 VDC) for powering the components of device. The circuit 118 includes transistors Q1 and Q2. The transistor Q1 rectifies the input AC voltage signal from the AC power source (not shown) and produces a root means square (RMS) signal across capacitor C1. The transistor Q2 receives the RMS signal and produces the first DC voltage (12 VDC) and the second DC voltage (5 VDC) for powering the components of device.

The base terminal of Q1 is connected to the Ground terminal through resistor R2 and the emitter terminal of Q1 is connected to the Ground terminal through capacitor C1. The collector terminal of Q1 is connected to the input AC source (not shown) through diode D1. A resistor R1 is coupled across the base and collector terminals of the transistor Q1. The transistor Q2 is configured as a series pass regulator having a base terminal connected to the Ground terminal through a zener diode Z1, a collector terminal connected to the emitter terminal of transistor Q1, and an emitter terminal for generating the first DC voltage (12 VDC) across capacitor C2 with respect to the Ground terminal. A resistor R3 is coupled across the base and collector terminals of the transistor Q2. A zener diode Z2 provides the second DC voltage (5 VDC) by coupling to the first DC voltage (12 VDC) through resistor R4. A capacitor C4 is coupled across the zener diode Z2 for improving the regulation of the second DC voltage provided by the diode Z2.

In operation, referring to FIG. 1, the input of the surge detector/counter device 102 is connected to the AC power source 104 such as 120V, 60 Hz AC power signal and the output of the device 102 is connected to the display means 106 such as an LCD display screen. Referring to FIG. 2, in response to a transient overvoltage condition (surge condition) having a magnitude greater than a nominal voltage (120, 60 Hz), a surge current signal flows through the primary section LP of the current sensor 10 which induces a surge voltage signal across the secondary section LS of the current sensor. Referring to FIG. 3, the surge voltage signal is fed to the input sections of amplifiers A1 and A2 through one of the three sensitivity resistor series combinations depending upon the sensitivity setting of switch SW1. For example, when switch SW1 is set to the High level, the surge voltage signal is applied to resistors R5 and R9. If the surge voltage signal has a positive magnitude greater than the reference, then amplifier A2 generates a positive output voltage. Likewise, if the surge voltage signal has a negative magnitude greater than the reference, then amplifier A1 generates a positive output voltage.

Referring to FIG. 4, the surge processing circuit 112 receives the output voltages from the amplifiers A1 and A2 of selector circuit 110 (FIG. 3). The output voltages charge capacitor C4 sufficient to trigger the base of transistor Q3 to make transistor Q3 conduct. When transistor Q3 conducts, charging capacitor C7 charges to a voltage providing a signal or count value indicating the occurrence of the surge condition. The signal is sent to the display means 106 (FIG. 1), through the output terminals O1-O6, which displays the signal as data representing the number of occurrences or count of surges.

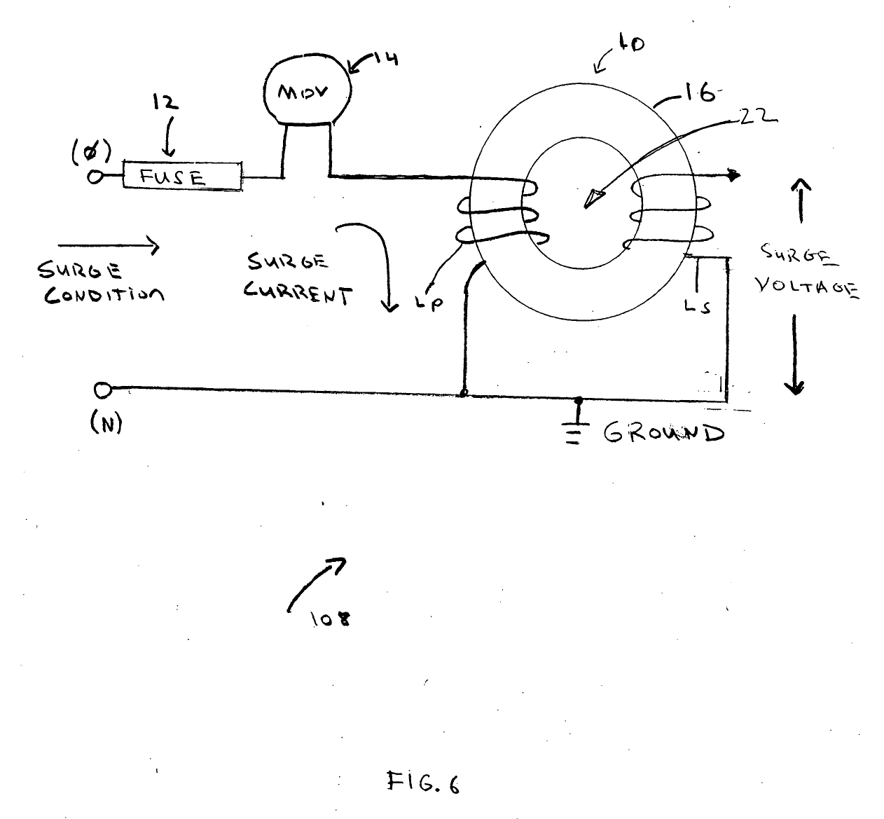

FIG. 6 is an embodiment of the surge detector circuit 108 of FIG. 1. The current sensor 10 is shown as a toroid magnetic core 16 with a central opening 22. As described above, the current sensor 10 includes a primary section LP wound with conductive wires (windings) and a secondary section LS also wound with wire. During a surge condition, a surge current flows through the primary section LP which is magnetically coupled to the secondary section LS. The surge current signal induces a surge voltage signal, which is proportional to the surge current signal, across the secondary section LS. The surge suppressor 12 is shown as an MOV having a first terminal lead 18 and a second terminal lead 20. The first terminal lead 18 is connected to the Phase terminal through the fuse F1. A portion of the second terminal lead 20 extends through the central opening 22 of the magnetic core and connects to the primary section windings LP of the toroid 10. The arrangement of the terminal lead 20 in this manner makes the circuit perform as an inrush current generator, resulting in improved current sensitivity and performance.

The current sensor 10 is shown as a toroid having a generally circular shaped magnetic core with a central opening, however, it should be understood that other embodiments of current sensors are possible. For example, a current sensor can be a transformer having a substantially square magnetic core with a central opening and primary and secondary sections. In addition, the surge suppressor 14 is shown as an MOV, however, it should be understood that other embodiments of surge suppressors are possible. For example, the surge suppressor can include a two terminal gas discharge tube which operates using an inert gas as the conductor between the two terminals.

While there have been shown and described and pointed out the fundamental features of the invention as applied to the preferred embodiment, it will be understood that various omissions and substitutions and changes of the form and details of the device described and illustrated and in its operation may be made by those skilled in the art. without departing from the spirit of the invention.

What is claimed is:

1. A surge detector/counter comprising:
a surge suppressor connected to an alternating current (AC) power source; and
a current sensor connected in series with the surge suppressor, wherein the current sensor, in response to a surge current flowing through the surge suppressor, generates a surge voltage signal for counting the number of occurrences of a surge condition.

2. The surge detector/counter of claim 1, wherein the current sensor is a transformer having a magnetic core.

3. The surge detector/counter of claim 2, wherein the transformer has a primary section wound with wire having ends for connection to an AC power source, and a secondary section wound with wire having ends for generating the surge voltage signal.

4. The surge detector/counter of claim 2, wherein the magnetic core is a toroid having a substantially circular shape.

5. The surge detector/counter of claim 4, wherein at least a portion of a lead of the surge suppressor extends through the magnetic core.

6. The surge detector/counter of claim 1, wherein the surge suppressor is a metal oxide varistor (MOV).

7. The surge detector/counter of claim 1, further comprising a surge sensitivity circuit operatively coupled to the current sensor for providing a selectable means for selecting a surge condition sensitivity level for the surge voltage signal.

8. The surge detector/counter of claim 1, further comprising a surge sensitivity circuit that includes a positive comparator circuit that generates an output signal based on whether a positive portion of the surge voltage signal exceeds a predetermined threshold, and a negative comparator that generates an output signal based on whether a negative portion of the surge voltage signal exceeds a predetermined voltage.

9. The surge detector/counter of claim 8, further comprising a surge voltage processing circuit for generating an output signal based on the positive and negative portions of the surge voltage signal.

10. The surge detector/counter of claim 1, further comprising a storage means operatively coupled to the output of the current sensor for storing a data value representing the number occurrences of surge conditions based on the surge voltage signal.

11. The surge detector/counter of claim 1, further comprising a display means operatively coupled to an output of the current sensor for displaying a data value representing the number of occurrences of surge conditions based on the surge voltage signal.

12. The surge detector/counter of claim 11, wherein the display means is a liquid crystal display (LCD).

13. The surge detector/counter of claim 1, further comprising a reset means for resetting a storage means which stores a signal representing a surge condition.

14. The surge detector/counter of claim 13, wherein the storage means is a capacitor for storing a charge having a value based on the surge voltage signal generated in response to a surge condition.

15. The surge detector/counter of claim 1, further comprising a direct current (DC) power source circuit for providing DC power to the detector/counter circuit.
